(19) United States
(12) Patent Application Publication
(10) Pub. No.: US 2002/0147244 A1
(43) Pub. Date: Oct. 10, 2002

(54) Injection-molded crystalline/semicrystalline material

(76) Inventors: Levi A. Kishbaugh, Groveland, MA (US); Roland Y. Kim, Somerville, MA (US); Kevin J. Levesque, Andover, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/801,199

(22) Filed: Mar. 7, 2001

(51) Int. Cl. B29D 7/00; C08J 9/00; C08G 63/00; D01F 1/02

(52) U.S. Cl. 521/50; 521/79; 521/182; 264/45.9; 264/46.1; 264/211

(57) ABSTRACT

Molding, including injection molding, of crystalline or semicrystalline polymeric material is described. Microcellular polymeric material is preferred. The invention involves use of a viscosity-reducing additive in molding that results in relatively better crystallinity at relatively lower mold temperatures, and lower aging time.

### FIELD OF THE INVENTION

The invention relates generally to the injection molding of crystalline or semicrystalline material with a viscosity-reducing additive, resulting in material with improved crystallinity at given conditions.

### BACKGROUND OF THE INVENTION

Injection molding of polymeric material is a well-developed field of technology. Injection molding typically involves heating polymeric material in an extruder to cause it to melt, injecting the molten polymeric material into a mold, allowing the polymeric material to cool and harden within the mold, and removing a resultant article from the mold. Injection molding of solid articles, as well as foam articles, is known in the art.

Injection-molded foam materials can be referred to as “structural foamed materials”. Structural foamed materials can be produced by injecting a physical blowing agent into a molten polymeric stream, dispersing the blowing agent in the polymer to form a mixture of blowing agent cells in polymer, injecting the mixture into a mold having a desired shape, and allowing the mixture to solidify therein. A pressure drop in the mixture can cause the cells in the polymer to grow. As an alternative to a physical blowing agent, a chemical blowing agent can be used which undergoes a chemical reaction in the polymer material causing formation of a gas. Chemical blowing agents generally are low molecular weight organic compounds that decompose at a critical temperature and release a gas such as nitrogen, carbon dioxide, or carbon monoxide. Under some conditions the cells can be made to remain isolated, and a closed-cell foamed material results. Under other, typically more violent foaming conditions, the cells rupture or become interconnected and an open-cell material results.

Microcellular material typically is defined by polymeric foam of very small cell size and various microcellular material is described in U.S. Pat. Nos. 5,158,986 and 4,473,665. These patents describe subjecting a single-phase solution of polymeric material and physical blowing agent to thermodynamic instability required to create sites of nucleation of very high density, followed by controlled cell growth to produce microcellular material. U.S. Pat. No. 4,473,665 (Martini-Vvedensky) describes a molding system and method for producing microcellular parts. Polymeric pellets are pre-pressurized with a gaseous blowing agent and melted in a conventional extruder to form a solution of blowing agent and molten polymer, which then is extruded into a pressurized mold cavity. The pressure in the mold is maintained above the solubility pressure of the gaseous blowing agent at melt temperatures for given initial saturation. When the molded part temperature drops to the appropriate critical nucleation temperature, the pressure on the mold is dropped, typically to ambient, and the part is allowed to foam.

U.S. Pat. No. 5,158,986 (Cha et al.) describes an alternative molding system and method for producing microcellular parts. Polymeric pellets are introduced into a conventional extruder and melted. A blowing agent of carbon dioxide in its supercritical state is established in the extrusion barrel and mixed to form a homogenous solution of blowing agent and polymeric material. A portion of the extrusion barrel is heated so that as the mixture flows through the barrel, a thermodynamic instability is created, thereby creating sites of nucleation in the molten polymeric material. The nucleated material is extruded into a pressurized mold cavity. Pressure within the mold is maintained by counter pressure of air. Cell growth occurs inside the mold cavity when the mold cavity is expanded and the pressure therein is reduced rapidly; expansion of the mold provides a molded and foamed article having small cell sizes and high cell densities. Nucleation and cell growth occur separately according to the technique; thermally-induced nucleation takes place in the barrel of the extruder, and cell growth takes place in the mold.

International Patent Publication No. WO 00/26005, published May 11, 2000, describes molded polymeric material including microcellular, injection molded, and low density polymeric material. Polymeric material is mixed with a physical blowing agent such as CO₂ to form a single-phase solution, and subsequently injected into a mold to form a molded article. A variety of molded articles including those with thick sections, those with thin sections, those with a smooth outer skin, etc. can be produced. The single-phase solution can be nucleated during injection into the mold.

While the above and other reports represent several techniques associated with the manufacture of microcellular material and the manufacture of material via injection molding, a need exists in the art for improved crystalline and semicrystalline injection molded products.

### SUMMARY OF THE INVENTION

The present invention provides a series of articles and methods associated with molding of crystalline or semicrystalline material. Generally, the invention involves the surprising discovery that use of a viscosity-reducing additive in molding results in articles with greater crystallinity under essentially identical conditions, or at least equal crystallinity at lower mold temperatures. Lower mold temperatures reduce cooling time, which reduces cycle time and increases productivity. In typical known techniques, processing can be carried out under conditions such that appreciable crystallinity results. But under other conditions, crystallization can be low or essentially zero. The conditions required for appreciable crystallinity (using typical known techniques) can be time-consuming, lowering productivity. The present invention increases productivity with high crystallization. The invention is surprising in that those of ordinary skill in the art would not expect to be able to achieve equal crystallinity at lower melt temperatures, or lower mold temperature, or to achieve better crystallinity at the same or lower melt temperatures. It is assumed in the industry that crystallinity is related to cooling rate, specifically, higher crystallinity results at lower cooling rates and thus at higher mold temperatures. It is also surprising that reduced aging time can be achieved, in accordance with the invention, at lower mold temperatures.

Molding in accordance with the invention also can be carried out at reduced pressure, which can reduce or eliminate damage to inserts around which molding occurs.

In addition, aging time to specific final crystallinity is reduced in accordance with the invention. In injection molding of crystalline or semicrystalline material using known techniques, it can take up to 21 days for molded articles to reach stable crystallization states. Slow changes in dimension and wear resistance of the articles can occur over this aging time, and articles must be maintained in storage during this time. In the process of the present invention, the aging time to specific final crystallinity is reduced, and can be essentially zero.

The invention involves the use of essentially any viscosity-reducing additive in connection with molding of polymeric or crystalline or semicrystalline materials. Preferred viscosity reducing additives include blowing agents such as supercritical fluids as described more fully below. While not wishing to be bound by any theory, the inventors suggest that molecules of the viscosity-reducing additive intercalate into and disturb the polymer matrix thus causing crystalline or semicrystalline polymer molecules to be disentangled from each other to some extent, allowing more freedom to arrange in a crystalline or semicrystalline state.

In one aspect the invention provides a series of molded articles. One article is an injection molded crystalline or semicrystalline microcellular article including at least one portion having a crystallinity of at least about 25%.

In another aspect the invention provides a series of methods. One method involves injection molding a crystalline or semicrystalline material at a mold temperature less than about 65° C., and recovering from the mold a crystalline or semicrystalline article including at least one portion having a crystallinity of at least about 25%.

In another embodiment a method of the invention involves injection molding a crystalline or semicrystalline material in the absence of a viscosity-reducing additive at a first mold temperature. A crystalline or semicrystalline article having crystallinity of a first value is recovered from the mold. The material is mixed with a viscosity-reducing additive and injection molded at a second temperature at least 5° C. lower than the first mold temperature, and a crystalline or semicrystalline article is recovered from the mold having crystallinity of at least the first value.

In another embodiment, a method involves injection molding a crystalline or semicrystalline material mixed with a viscosity-reducing additive at a first mold temperature, and recovering from the mold a crystalline or semicrystalline article having crystallinity of a first value. It is a characteristic that material, injection molded under essentially identical conditions except in the absence of a viscosity-reducing additive and at a different mold and optionally different barrel temperature, requires molding at a second mold temperature at least 5° C. higher than the first temperature to produce a crystalline or semicrystalline article having crystallinity of at least the first value.

In another embodiment a method involves injection molding a crystalline or semicrystalline material in the absence of a viscosity-reducing additive at a first mold temperature and recovering from the mold a first crystalline or semicrystalline article having a crystallinity of a first value. The material, mixed with a viscosity-reducing additive, is injection molded at a second mold temperature no greater than the first mold temperature and a second crystalline or semicrystalline article is recovered from the mold having crystallinity at least 2% greater than the first value.

In another embodiment a method involves injection molding a crystalline or semicrystalline material mixed with a viscosity-reducing additive at a first mold temperature and recovering from the mold a first crystalline or semicrystalline article having crystallinity of a first value. It is a characteristic that the material, injection molded under essentially identical conditions except in the absence of a viscosity-reducing additive, results in a second crystalline or semicrystalline article having crystallinity at least 2% less than the first value.

In another embodiment a method involves injection molding a crystalline or semicrystalline material to form an injection-molded product that does not change in crystallinity more than 10% after 30 minutes after removal from the mold. According to this recitation crystallinity is measured after 30 minutes (or other time period set forth herein) relative to crystallinity immediately upon removal from the mold and cooling (if necessary) to a temperature at which crystallinity can be measured.

Other advantages, novel features, and objects of the invention will become apparent from the following detailed description of the invention when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

In the drawings:

FIG. 1 illustrates a microcellular injection or intrusion molding system of the present invention, including an extrusion system having a nucleating pathway defining an orifice of a molding chamber;

FIG. 2 illustrates a preferred multi-hole blowing agent feed orifice arrangement and extrusion screw in the system of FIG. 1;

FIG. 3 illustrates a microcellular injection molding system of the invention including an accumulator;

FIG. 4 is a photocopy of a scanning electron micrograph (SEC) image of a molded article produced according to the invention;

FIGS. 5A, 5B, 5C, and 5D are photocopies of SEC images of molded articles produced according to the invention; and

FIGS. 6A and 6B are photocopies of SEC images of molded articles produced according to the invention.

### DETAILED DESCRIPTION OF THE INVENTION

Commonly-owned, co-pending international patent publication nos. WO 98/08667, published Mar. 5, 1998, WO 98/31521, published Jul. 23, 1998, and WO 00/26005, published May 11, 2000 are incorporated herein by reference.

The various embodiments and aspects of the invention will be better understood from the following definitions. As used herein, “nucleation” defines a process by which a homogeneous, single-phase solution of polymeric material, in which is dissolved molecules of a species that is a gas under ambient conditions, undergoes formations of clusters of molecules of the species that define “nucleation sites”, from which cells will grow. This definition of “nucleation sites” should not be confused with sites at which nucleating agent (defined below) particles exist. However, under appropriate conditions, sites at which nucleating agent particle exist can become nucleation sites. Nucleation means a change from a homogeneous, single-phase solution to a mixture in which sites of aggregation of at least several molecules of blowing agent are formed. Nucleation defines that transitory state when gas, in solution in a polymer melt, comes out of solution to form a suspension of bubbles within the polymer melt. Generally this transition state is forced to occur by changing the solubility of the polymer melt from a state of sufficient solubility to contain a certain quantity of gas in solution to a state of insufficient solubility to contain that same quantity of gas in solution. Nucleation can be effected by subjecting the homogeneous, single-phase solution to rapid thermodynamic instability, such as rapid temperature change, rapid pressure drop, or both. Rapid pressure drop can be created using a nucleating pathway, defined below. Rapid temperature change can be created using a heated portion of an extruder, a hot glycerin bath, or the like. “Microcellular nucleation”, as used herein, means nucleation at a cell density high enough to create microcellular material upon controlled expansion. As used herein, “nucleation” defines the process by which gas molecules coalesce and eventually form cells, and is not to be confused with nucleation associated with crystallization.

A “nucleating agent” is a dispersed agent, such as talc or other filler particles, added to a polymer and able to promote formation of nucleation sites from a single-phase, homogeneous solution. “Nucleated” refers to a state of a fluid polymeric material that had contained a single-phase, homogeneous solution including a dissolved species that is a gas under ambient conditions, following an event (typically thermodynamic instability) leading to the formation of nucleation sites. “Non-nucleated” refers to a state defined by a homogeneous, single-phase solution of polymeric material and dissolved species that is a gas under ambient conditions, absent nucleation sites. A “non-nucleated” material can include nucleating agent such as talc.

A “polymeric material/blowing agent mixture” can be a single-phase, non-nucleated solution of at least the two, a nucleated solution of at least the two, or a mixture in which blowing agent cells have grown.

“Nucleating pathway” is meant to define a pathway that forms part of microcellular polymeric foam extrusion apparatus and in which, under conditions in which the apparatus is designed to operate (typically at pressures of from about 1500 to about 30,000 psi upstream of the nucleator and at flow rates of greater than about 0.1 pounds polymeric material per hour), the pressure of a single-phase solution of polymeric material admixed with blowing agent in the system drops below the saturation pressure for the particular blowing agent concentration at a rate or rates facilitating rapid nucleation. A nucleating pathway defines, optionally with other nucleating pathways, a nucleation or nucleating region of a device of the invention.

“Reinforcing agent”, as used herein, refers to auxiliary, essentially solid material constructed and arranged to add dimensional stability, or strength or toughness, to material. Such agents are typified by fibrous material as described in U.S. Pat. Nos. 4,643,940 and 4,426,470. “Reinforcing agent” does not, by definition, necessarily include filler or other additives that are not constructed and arranged to add dimensional stability. Those of ordinary skill in the art can test an additive to determine whether it is a reinforcing agent in connection with a particular material.

“Viscosity-reducing additive”, as used herein, includes any of a variety of additives known to those of ordinary skill in the art to reduce viscosity. Preferred are additives that reduce viscosity and do not remain, in appreciable quantity, in a final, molded product, or are completely absent from a final molded product. Additionally, a viscosity-reducing additive is preferably selected so as not to affect crystallinity of the product. Selection of additives according to these criteria are within the skill of those of ordinary skill in the art. Preferred viscosity-reducing additives are those that are volatile, preferably those that are gases at room temperature. Examples include physical blowing agents such as hydrocarbons and atmospheric gases. Particularly preferred in the present invention are atmospheric gases such as carbon dioxide, nitrogen, helium, etc. Where hydrocarbons are selected, low-molecular-weight hydrocarbons are preferred. Other exemplary additives include the well-known CFCs, HFCs, and HCFCs.

The present invention provides systems and methods for the intrusion and injection molding of crystalline or semicrystalline polymeric material, including microcellular polymeric material, and systems and methods useful in intrusion and injection molding and also useful in connection with other techniques. For example, although injection and intrusion molding are primarily described, the invention can be modified readily by those of ordinary skill in the art for use in other molding methods such as, without limitation, low-pressure molding, co-injection molding, laminar molding, injection compression, and the like. “Injection molding”, as used herein, includes by definition all of the above techniques.

For purposes of the present invention, microcellular material is defined as foamed material having an average cell size of less than about 100 microns in diameter, or material of cell density of generally greater than at least about 106 cells per cubic centimeter, or preferably both. Non-microcellular foams have cell sizes and cell densities outside of these ranges. The void fraction of microcellular material generally varies from 3% to 98%.

In preferred embodiments, microcellular material of the invention is produced having average cell size of less than about 50 microns. In some embodiments particularly small cell size is desired, and in these embodiments material of the invention has average cell size of less than about 20 microns, more preferably less than about 10 microns, and more preferably still less than about 5 microns. The microcellular material preferably has a maximum cell size of about 100 microns. In embodiments where particularly small cell size is desired, the material can have maximum cell size of about 50 microns, more preferably about 25 microns, more preferably about 15 microns, more preferably about 8 microns, and more preferably still about 5 microns. A set of embodiments includes all combinations of these noted average cell sizes and maximum cell sizes. For example, one embodiment in this set of embodiments includes microcellular material having an average cell size of less than about 30 microns with a maximum cell size of about 50 microns, and as another example an average cell size of less than about 30 microns with a maximum cell size of about 35 microns, etc. That is, microcellular material designed for a variety of purposes can be produced having a particular combination of average cell size and a maximum cell size preferable for that purpose. Control of cell size is described in greater detail below.

In one embodiment, essentially closed-cell microcellular material is produced in accordance with the techniques of the present invention. As used herein, “essentially closed-cell” is meant to define material that, at a thickness of about 100 microns, contains no connected cell pathway through the material.

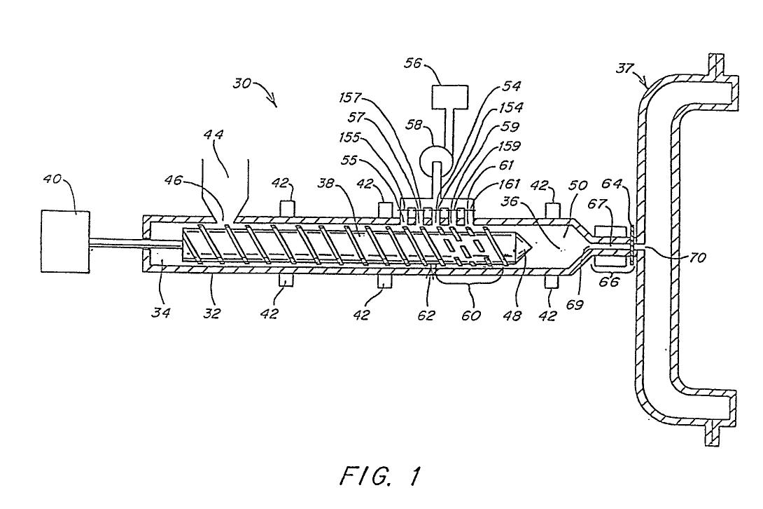

Referring now to FIG. 1, a molding system 30 is illustrated schematically that can be used to carry out molding according to a variety of embodiments of the invention.

System 30 of FIG. 1 includes a barrel 32 having a first, upstream end 34, and a second, downstream end 36 connected to a molding chamber 37. Mounted for rotation within barrel 32 is a screw 38 operably connected, at its upstream end, to a drive motor 40. Although not shown in detail, screw 38 includes feed, transition, gas injection, mixing, and metering sections.

Positioned along barrel 32, optionally, are temperature control units 42. Control units 42 can be electrical heaters, can include passageways for temperature control fluid, and or the like. Units 42 can be used to heat a stream of pelletized or fluid polymeric material within the barrel to facilitate melting, and/or to cool the stream to control viscosity and, in some cases, blowing agent solubility. The temperature control units can operate differently at different locations along the barrel, that is, to heat at one or more locations, and to cool at one or more different locations. Any number of temperature control units can be provided.

Barrel 32 is constructed and arranged to receive a precursor of crystalline or semicrystalline polymeric material. As used herein, “precursor of polymeric material” is meant to include all materials that are fluid, or can form a fluid and that subsequently can harden to form a polymeric article. Typically, the precursor is defined by thermoplastic polymer pellets, but can include other species.

Preferably, a thermoplastic polymer or combination of thermoplastic polymers is selected from among semicrystalline and crystalline material including polyolefins such as polyethylene and polypropylene, crosslinkable polyolefins, polyesters such as PET, PBT, polycyclohexanedimethylterephthalate (PCT), crystallizable polyamides such as nylon-6 and nylon-6,6, etc., acetals, liquid crystal polymers such as XYDAR™, fluoroeslastomeric polymers (FEPs), and the like, and copolymers of these that are crystalline or semicrystalline. In particular, unmodified standard production grade material can be used in contrast to standard prior art materials which, it typically has been taught, require modifications such as incorporation of foam-controllability additives including components of other polymer families (e.g. polycarbonate in polyethylene terephthalate) (see, for example, Boone, G. (Eastman Chemical Co.), “Expanded Polyesters for Food Packaging”, Conference Proceedings of Foam Conference, Sep. 10-12, 1996, Somerset, N.J.). These additives increase the controllability of foaming by generally functioning to increase melt strength and/or melt elasticity. In this aspect, microcellular material can be made having preferred average cell sizes, maximum cell sizes, and cell densities as described above, and can be processed according to techniques and systems described herein. Examples of material that do not include foam-controllability modifiers include Eastman 9663 PET and Wellman 61802 PET. According to the method, semicrystalline or crystalline microcellular material may be made having preferred average cell sizes, maximum cell sizes, and cell densities as described herein.

The polymeric material can, optionally, include a reinforcing agent as described above. For example, glass fibers can be used, including relatively short fibers, for example those of from about 0.6 to about 1 cm can be used, or relatively long fibers such as those of mean length of about 1.3 cm, 1.4 cm, 1.5 cm, or longer.

Typically, introduction of the precursor of polymeric material utilizes a standard hopper 44 for containing pelletized polymeric material to be fed into the extruder barrel through orifice 46, although a precursor can be a fluid prepolymeric material injected through an orifice and polymerized within the barrel via, for example, auxiliary polymerization agents. In connection with the present invention, it is important only that a fluid stream of polymeric material be established in the system.

Immediately downstream of downstream end 48 of screw 38 in FIG. 1 is a region 50 which can be a temperature adjustment and control region, auxiliary mixing region, auxiliary pumping region, or the like. For example, region 50 can include temperature control units to adjust the temperature of a fluid polymeric stream prior to nucleation, as described below. Region 50 can include instead, or in addition, additional, standard mixing units (not shown), or a flow-control unit such as a gear pump (not shown). In another embodiment, region 50 can be replaced by a second screw in tandem which can include a cooling region. In an embodiment in which screw 38 is a reciprocating screw in an injection molding system, described more fully below, region 50 can define an accumulation region in which a single-phase, non-nucleated solution of polymeric material and a blowing agent is accumulated prior to injection into mold 37.

Molded material production according to the present invention preferably uses a physical blowing agent, that is, an agent that is a gas under ambient conditions (described more fully below). However, chemical blowing agents can be used and can be formulated with polymeric pellets introduced into hopper 44. Suitable chemical blowing agents include those typically relatively low molecular weight organic compounds that decompose at a critical temperature or another condition achievable in extrusion and release a gas or gases such as nitrogen, carbon dioxide, or carbon monoxide. Examples include azo compounds such as azo dicarbonamide.

As mentioned, in preferred embodiments a physical blowing agent is used. One advantage of embodiments in which a physical blowing agent, rather than a chemical blowing agent, is used is that recyclability of product is maximized. Use of a chemical blowing agent typically reduces the attractiveness of a polymer to recycling since residual chemical blowing agent and blowing agent by-products contribute to an overall non-uniform recyclable material pool. Since foams blown with chemical blowing agents inherently include a residual, unreacted chemical blowing agent after a final foam product has been produced, as well as chemical by-products of the reaction that forms a blowing agent, material of the present invention in this set of embodiments includes residual chemical blowing agent, or reaction by-product of chemical blowing agent, in an amount less than that inherently found in articles blown with 0.1% by weight chemical blowing agent or more, preferably in an amount less than that inherently found in articles blown with 0.05% by weight chemical blowing agent or more. In particularly preferred embodiments, the material is characterized by being essentially free of residual chemical blowing agent or free of reaction by-products of chemical blowing agent. That is, they include less residual chemical blowing agent or by-product that is inherently found in articles blown with any chemical blowing agent. In this embodiment, along barrel 32 of system 30 is at least one port 54 in fluid communication with a source 56 of a physical blowing agent.

Any of a wide variety of physical blowing agents known to those of ordinary skill in the art such as helium, hydrocarbons, chlorofluorocarbons, nitrogen, carbon dioxide, and the like can be used in connection with the invention, or mixtures thereof, and, according to a preferred embodiment, source 56 provides nitrogen or carbon dioxide as a blowing agent. Supercritical fluid blowing agents are especially preferred, in particular supercritical carbon dioxide or supercritical nitrogen. In one embodiment solely supercritical nitrogen or carbon dioxide is used as blowing agent. Supercritical nitrogen or carbon dioxide can be introduced into the extruder and made to form rapidly a single-phase solution with the polymeric material either by injection as a supercritical fluid, or injection as a gas or liquid and allowing conditions within the extruder to render the blowing agent supercritical in many cases within seconds. Injection of nitrogen or carbon dioxide into the extruder in a supercritical state is preferred. The single-phase solution of supercritical fluid and polymeric material formed in this manner has a very low viscosity which advantageously allows lower temperature molding, as well as rapid filling of molds having close tolerances to form very thin molded parts, which is discussed in greater detail below.

A pressure and metering device 58 typically is provided between blowing agent source 56 and that at least one port 54. Device 58 can be used to meter the mass of the blowing agent between 0.01 lbs/hour and 70 lbs/hour, or between 0.04 lbs/hour and 70 lbs/hour, and more preferably between 0.2 lbs/hour and 12 lbs/hour so as to control the amount of the blowing agent in the polymeric stream within the extruder to maintain blowing agent at a desired level. According to one set of embodiments, the amount, or mass flow rate of blowing agent in the polymeric stream is metered so as to be between about 0.05% and 25% by weight of the mixture of polymeric material and blowing agent, preferably between about 0.1% and 2.0% by weight, more preferably between about 0.2% and 1% by weight, based on the weight of the polymeric stream and blowing agent. The particular blowing agent used (carbon dioxide, nitrogen, etc.) and the amount of blowing agent used is often dependent upon the polymer, the density reduction, cell size and physical properties desired. In embodiments where nitrogen is used as blowing agent, blowing agent is present in an amount between 0.05% and 2.5%, preferably between 0.1% and 1.0% in some cases, and where carbon dioxide is used as blowing agent the mass flow of the blowing agent can be between 0.05% and 10% in some cases, between 0.1% and 2.0% in preferred embodiments.

The pressure and metering device can be connected to a controller (not shown) that also is connected to drive motor 40 to control metering of blowing agent in relationship to flow of polymeric material to very precisely control the weight percent blowing agent in the fluid polymeric mixture. For example, the mass flow rate of the blowing agent can be controlled so that it varies by no more than +/−0.3% in preferred cases.

Although port 54 can be located at any of a variety of locations along the barrel, according to a preferred embodiment it is located just upstream from a mixing section 60 of the screw and at a location 62 of the screw where the screw includes unbroken flights.

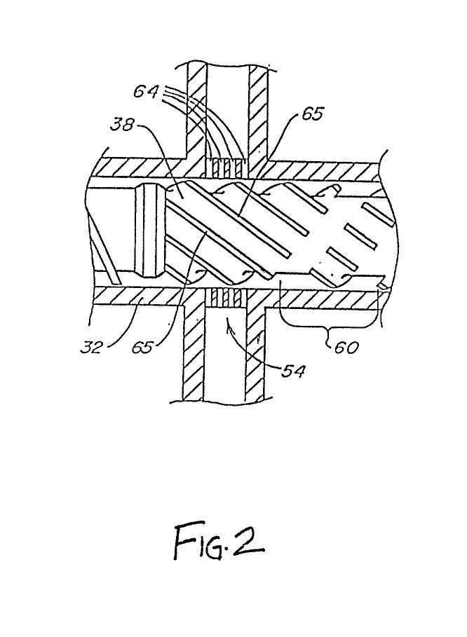

Referring now to FIG. 2, a preferred embodiment of the blowing agent port is illustrated in greater detail and, in addition, two ports on opposing top and bottom sides of the barrel are shown. In this preferred embodiment, port 54 is located at a region upstream from mixing section 60 of screw 38 (including highly-broken flights) at a distance upstream of the mixing section of no more than about 4 full flights, preferably no more than about 2 full flights, or no more than 1 full flight. Positioned as such, injected blowing agent is very rapidly and evenly mixed into a fluid polymeric stream to quickly produce a single-phase solution of the foamed material precursor and the blowing agent.

Port 54, in the preferred embodiment illustrated, is a multi-hole port including a plurality of orifices 64 connecting the blowing agent source with the extruder barrel. As shown, in preferred embodiments a plurality of ports 54 are provided about the extruder barrel at various positions radially and can be in alignment longitudinally with each other. For example, a plurality of ports 54 can be placed at the 12 o'clock, 3 o'clock, 6 o'clock, and 9 o'clock positions about the extruder barrel, each including multiple orifices 64. In this manner, where each orifice 64 is considered a blowing agent orifice, the invention includes extrusion apparatus having at least about 10, preferably at least about 40, more preferably at least about 100, more preferably at least about 300, more preferably at least about 500, and more preferably still at least about 700 blowing agent orifices in fluid communication with the extruder barrel, fluidly connecting the barrel with a source of blowing agent.

Also in preferred embodiments is an arrangement (as shown in FIG. 2) in which the blowing agent orifice or orifices are positioned along the extruder barrel at a location where, when a preferred screw is mounted in the barrel, the orifice or orifices are adjacent full, unbroken flights 65. In this manner, as the screw rotates, each flight, passes, or “wipes” each orifice periodically. This wiping increases rapid mixing of blowing agent and fluid foamed material precursor by, in one embodiment, essentially rapidly opening and closing each orifice by periodically blocking each orifice, when the flight is large enough relative to the orifice to completely block the orifice when in alignment therewith. The result is a distribution of relatively finely-divided, isolated regions of blowing agent in the fluid polymeric material immediately upon injection and prior to any mixing. In this arrangement, at a standard screw revolution speed of about 30 rpm, each orifice is passed by a flight at a rate of at least about 0.5 passes per second, more preferably at least about 1 pass per second, more preferably at least about 1.5 passes per second, and more preferably still at least about 2 passes per second. In preferred embodiments, orifices 54 are positioned at a distance of from about 15 to about 30 barrel diameters from the beginning of the screw (at upstream end 34).

Referring again to FIG. 1, downstream of region 50 is a nucleator 66 constructed to include a pressure-drop nucleating pathway 67. As used herein, “nucleating pathway” in the context of rapid pressure drop is meant to define a pathway that forms part of microcellular polymer foam extrusion apparatus and in which, under conditions in which the apparatus is designed to operate (typically at pressures of from about 1500 to about 30,000 psi upstream of the nucleator and at flow rates of greater than about 0.1 lbs polymeric material per hour), the pressure of a single-phase solution of polymeric material admixed with blowing agent in the system drops below the saturation pressure for the particular blowing agent concentration at a rate or rates facilitating nucleation. Nucleating pathway 67 includes an inlet end 69 for receiving a single-phase solution of polymeric material precursor and blowing agent as a fluid polymeric stream, and a nucleated polymer releasing end 70 for delivering nucleated polymeric material to molding chamber, or mold, 37. Nucleator 66 can be located in a variety of locations downstream of region 50 and upstream of mold 37. In a preferred embodiment, nucleator 66 is located in direct fluid communication with mold 37, such that the nucleator defines a nozzle connecting the extruder to the molding chamber and the nucleated polymer releasing end 70 defines an orifice of molding chamber 37. According to one set of embodiments, the invention lies in placing a nucleator upstream of a mold. Although not illustrated, another embodiment of nucleator 66 includes a nucleating pathway 67 constructed and arranged to have a variable cross-sectional dimension, that is, a pathway that can be adjusted in cross-section. A variable cross-section nucleating pathway allows the pressure drop rate in a stream of fluid polymeric material passing therethrough to be varied in order to achieve a desired nucleation density.

In one embodiment, a nucleating pathway that changes in cross-sectional dimension along its length is used. In particular, a nucleating pathway that decreases in cross-sectional dimension in a downstream direction can significantly increase pressure drop rate thereby allowing formation of microcellular material of very high cell density using relatively low levels of blowing agent. These and other exemplary and preferred nucleators are described in co-pending International patent publication no. WO 98/08667 referenced above.

While pathway 67 defines a nucleating pathway, some nucleation also may take place in the mold itself as pressure on the polymeric material drops at a very high rate during filling of the mold.

The system of FIG. 1 illustrates one general embodiment of the present invention in which a single-phase, non-nucleated solution of polymeric material and blowing agent is nucleated, via rapid pressure drop, while being urged into molding chamber 37 via the rotation action of screw 38. This embodiment illustrates an intrusion molding technique and, in this embodiment, only one blowing agent injection port 54 need be utilized.

In another embodiment, screw 38 of system 30 is a reciprocating screw and a system defines an injection molding system. In this embodiment screw 38 is mounted for reciprocation within barrel 32, and includes a plurality of blowing agent inlets or injection ports 54, 55, 57, 59, and 61 arranged axially along barrel 32 and each connecting barrel 32 fluidly to pressure and metering device 58 and a blowing agent source 56. Each of injection ports 54, 55, 57, 59, and 61 can include a mechanical shut-off valve 154, 155, 157, 159, and 161 respectively, which allow the flow of blowing agent into extruder barrel 38 to be controlled as a function of axial position of reciprocating screw 38 within the barrel. In operation, according to this embodiment, a charge of fluid polymeric material and blowing agent (which can be a single-phase, non-nucleated charge in some embodiments) is accumulated in region 50 downstream of the downstream end 48 of screw 38. Screw 38 is forced distally (downstream) in barrel 32 causing the charge in region 50 to be injected into mold 37. A mechanical shut-off valve 64, located near orifice 70 of mold 37, then can be closed and mold 37 can be opened to release an injection-molded part. Screw 38 then rotates while retracting proximally (toward the upstream end 34 of the barrel), and shut-off valve 161 is opened while shut-off valves 155, 157, 154, and 159 all are closed, allowing blowing agent to be injected into the barrel through distal-most port 61 only. As the barrel retracts while rotating, shut-off valve 161 is closed while shut-off valve 159 is opened, then valve 159 is closed while valve 154 is opened, etc. That is, the shut-off valves which control injection of blowing agent from source 56 into barrel 32 are controlled so that the location of injection of blowing agent moves proximally (in an upstream direction) along the barrel as screw 38 retracts proximally. The result is injection of blowing agent at a position along screw 38 that remains essentially constant. Thus, blowing agent is added to fluid polymeric material and mixed with the polymeric material to a degree and for a period of time that is consistent independent of the position of screw 38 within the barrel, and occurring, at times, while the screw is moving axially within the barrel. Toward this end, more than one of shut-off valves 155, 157, etc. can be open or at least partially open simultaneously to achieve smooth transition between injection ports that are open and to maintain essentially constant location of injection of blowing agent along barrel 38.

Once barrel 38 is fully retracted (with blowing agent having been most recently introduced through injection port 55 only), all of the blowing agent shut-off valves are closed. At this point, within distal region 50 of the barrel is an essentially uniform fluid polymeric material/blowing agent mixture. Shut-off valve 64 then is opened and screw 38 is urged distally to inject the charge of polymeric material and blowing agent into mold 37.

The embodiment of the invention involving a reciprocating screw can be used to produce non-microcellular foams or microcellular foam. Where non-microcellular foam is to be produced, the charge that is accumulated in distal region 50 can be a multi-phase mixture including cells of blowing agent in polymeric material, at a relatively low pressure. Injection of such a mixture into mold 37 results in cell growth and production of conventional foam. Where microcellular material is to be produced, a single-phase, non-nucleated solution is accumulated in region 50 and is injected into mold 37. In preferred embodiments, the single-phase solution is injected into the mold while nucleation takes place.

The described arrangement facilitates a method of the invention that is practiced according to another set of embodiments in which varying concentrations of blowing agent in fluid polymeric material is created at different locations in a charge accumulated in distal portion 50 of the barrel. This can be achieved by control of shut-off valves 155, 157, 154, 159, and 161 in order to achieve non-uniform blowing agent concentration. In this technique, articles having varying densities may be produced, such as, for example, an article having a solid exterior and a foamed interior.

Although not shown, molding chamber 37 can include vents to allow air within the mold to escape during injection. The vents can be sized to provide sufficient back pressure during injection to control cell growth so that uniform microcellular foaming occurs. In another embodiment, a single-phase, non-nucleated solution of polymeric material and blowing agent is nucleated while being introduced into an open mold, then the mold is closed to shape a microcellular article.

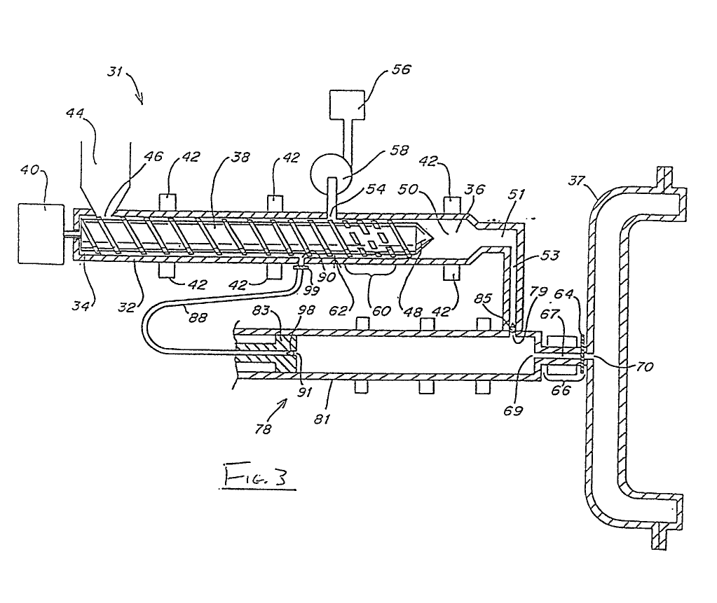

According to another embodiment an injection molding system utilizing a separate accumulator is provided. Referring now to FIG. 3, an injection molding system 31 includes an extruder similar to that illustrated in FIG. 1. The extruder can include a reciprocating screw as in the system of FIG. 1. At least one accumulator 78 is provided for accumulating molten polymeric material prior to injection into molding chamber 37. The extruder includes an outlet 51 fluidly connected to an inlet 79 of the accumulator via a conduit 53 for delivering a non-nucleated, single-phase solution of polymeric material and blowing agent to the accumulator.

Accumulator 78 includes, within a housing 81, a plunger 83 constructed and arranged to move axially (proximally and distally) within the accumulator housing. The plunger can retract proximally and allow the accumulator to be filled with polymeric material/blowing agent through inlet 79 and then can be urged distally to force the polymeric material/blowing agent mixture into mold 37. When in a retracted position, a charge defined by single-phase solution of molten polymeric material and blowing agent is allowed to accumulate in accumulator 78. When accumulator 78 is full, a system such as, for example, a hydraulically controlled retractable injection cylinder (not shown) forces the accumulated charge through nucleator 66 and the resulting nucleated mixture into molding chamber 37. This arrangement illustrates another embodiment in which a non-nucleated, single-phase solution of polymeric material and blowing agent is nucleated as a result of the process of filling the molding chamber. Alternatively, a pressure drop nucleator can be positioned downstream of region 50 and upstream of accumulator 78, so that nucleated polymeric material is accumulated, rather than non-nucleated material, which then is injected into mold 37.

In another arrangement, a reciprocating screw extruder such as that illustrated in FIG. 1 can be used with system 31 of FIG. 3 so as to successively inject charges of polymeric material and blowing agent (which can remain non-nucleated or can be nucleated while being urged from the extruder into the accumulator) while pressure on plunger 83 remains high enough so that nucleation is prevented within the accumulator (or, if nucleated material is provided in the accumulator cell growth is prevented). When a plurality of charges have been introduced into the accumulator, shut-off valve 64 can be opened and plunger 83 driven distally to transfer the charge within the accumulator into mold 37. This can be advantageous for production of very large parts.

A ball check valve 85 is located near the inlet 79 of the accumulator to regulate the flow of material into the accumulator and to prevent backflow into the extruder, and to maintain a system pressure required to maintain the single-phase solution of non-nucleated blowing agent and molten polymeric material or, alternatively, to prevent cell growth of nucleated material introduced therein. Optionally, injection molding system 31 can include more than one accumulator in fluid communication with extruder 30 and molding chamber 37 in order to increase rates of production.

System 31 also includes a blowing agent-free conduit 88 connecting an outlet 90 of the extruder with an accumulator inlet 91. Inlet 91 of the accumulator is positioned at the face of plunger 83 of the accumulator. A mechanical shut-off valve 99 is positioned along conduit 88, preferably near outlet 90. Extruder outlet 90 is located in the extruder upstream of blowing agent inlet 54 (or multiple blowing agent inlets, as in the extrusion arrangement illustrated in FIG. 1) but far enough downstream in the extruder that it can deliver fluid polymeric material 94. The fluid polymeric material 94 delivered by conduit 88 is blowing-agent-poor material, and can be essentially free of blowing agent. Thus, the system includes a first outlet 90 of the extruder positioned to deliver fluid polymeric material essentially free of blowing agent, or at reduced blowing agent concentration, from the extruder to a first inlet 91 of the accumulator, and a second outlet 51 downstream of the mixing region of the extruder positioned to deliver a mixture of fluid polymeric material and blowing agent (a higher blowing agent concentration than is delivered from outlet 90, i.e. blowing-agent-rich material) to a second inlet 79 of the accumulator. The accumulator can include heating units 96 to control the temperature of polymeric material therein. The accumulator includes an outlet that is the inlet 69 of nucleator 66. A passage (or nozzle) defining nucleating pathway 67 connects accumulator 78 to the molding chamber 37.

A series of valves, including ball check valves 98 and 85 located at the first and second inlets to the accumulator, and mechanical valves 64 and 99, respectively, control flow of material from the extruder to the accumulator and from the accumulator to the mold as desired, as described below according to some embodiments.

The invention involves, in all embodiments, the ability to maintain pressure throughout the system adequate to prevent premature nucleation where nucleation is not desirable (upstream of the nucleator), or cell growth where nucleation has occurred but cell growth is not desired or is desirably controlled.

A variety of articles can be produced according to the invention, for example, consumer goods and industrial goods such as electrical connectors, bobbins, polymeric cutlery, automotive components, and a wide variety of other injection molded parts.

The invention provides also for the production of molded microcellular polymeric articles or molded non-microcellular polymeric foam articles of a shape of a molding chamber, including at least one portion have a cross-sectional dimension of no more than about 0.125 inch or, in other embodiments, smaller dimensions noted above, the article having a void volume of at least about 5%. Preferably, the void volume is at least about 10%, more preferably at least about 15%, more preferably at least about 20%, more preferably at least about 25%, and more preferably still at least about 30%. In other embodiments the article has a void volume of at least about 50%. The invention also provides a system and method to produce thick and thin foam molded parts with surfaces replicating solid parts. At least a portion of the surface of these parts is free of splay and swirl visible to the naked human eye.

The systems of the invention can include a restriction element (not shown) as described in co-pending, commonly owned International Patent Publication no. WO 00/59702, published Oct. 12, 2000, entitled “Methods For Manufacturing Foam Material Including Systems With Pressure Restriction Element” which is incorporated herein by reference. The restriction element, such as a check valve, is positioned upstream of a blowing agent injection port to maintain the solution of polymer and blowing agent in the extruder above a minimum pressure throughout an injection cycle, and preferably above the critical pressure required for the maintenance of a single-phase solution of polymer and blowing agent.

The invention involves molding of crystalline or semicrystalline articles at relatively high crystallinity levels. “Crystallinity”, as used herein and referred to as a numerical percentage, means degree of crystallinity, i.e., the extent of crystallization within a polymer matrix, which is a property well known to those of ordinary skill in the art and can be readily measured using a variety of known analytical methods including differential scanning calorimetry (DSC). Preferred articles of the invention include at least one portion having crystallinity of at least 25%, more preferably at least 30%, or 35%, or 40%, or more preferably still at least 45%. Preferably, at least 25% of the volume of the molded article has at least one of the preferred crystallinities mentioned above, or at least about 50%, 75%, 90%, or essentially 100% of the volume of the article has one of these crystallinities. These preferred crystallinities, through the above-listed preferred volume percentages of the articles, can be found in articles according to any embodiment of the invention.

As mentioned, one surprising advantage of the invention is the ability to produce molded crystalline or semicrystalline articles with relatively high crystallinity at relatively low mold temperatures. Specifically, injection molding can occur at mold temperatures less than about 65° C., 45° C., 30° C., 20° C., or even less than 10° C. while recovering molded crystalline or semicrystalline articles including at least one portion having crystallinity of at least about 25% or other, higher crystallinities mentioned above. As in the above embodiments, these crystallinities can be found throughout at least 25% of the article's volume or other, higher percentages of the article's volume mentioned above. “Mold temperature”, in this context, means the average interior mold wall temperature.

As also mentioned above, the invention allows injection molding of crystalline or semicrystalline material with a viscosity-reducing additive at a mold temperature at least 5° lower than the mold temperature required to injection mold the same material in the absence of a viscosity-reducing additive, while achieving crystallinity of at least the same value as is achieved at the higher temperature without the viscosity-reducing additive. Molding can be accomplished, with the viscosity-reducing additive, at a mold temperature at least 15° C., 20° C., 35° C., 50° C., 75° C., or 85° C. lower than the mold temperature required in the absence of a viscosity-reducing additive while achieving at least the same crystallinity. Achieving at least the same crystallinity, in this context, means that the article molded using the viscosity-reducing additive at lower temperature has at least the same degree of crystallinity, throughout at least the same volume of the article, as the article molded at higher temperature without viscosity-reducing additive, or that the overall, average crystallinity of the article molded with the viscosity-reducing additive is at least as great as the overall, average crystallinity of the article produced without the viscosity-reducing additive.

It is another advantage of the invention that molded crystalline or semicrystalline articles can be produced having greater crystallinity, using a viscosity-reducing additive, then crystallinities achieved under essentially identical mold temperature conditions but without a viscosity-reducing additive. Specifically, crystalline or semicrystalline articles can be produced, using a viscosity-reducing additive, with at least 2% greater crystallinity than articles produced under essentially identical mold temperature conditions but without a viscosity-reducing additive. Preferably, these articles can be produced with crystallinity of at least 4%, 6%, 8%, 10%, 15%, or 20% greater than articles produced under essentially identical mold temperature conditions but without a viscosity-reducing additive. “At least 2% greater” (or other percentage), in this context, means that at least one portion of the article molded with the viscosity-reducing additive has crystallinity at least 2% greater than the identical portion of the article molded in the identical mold but without a viscosity-reducing additive, or that the overall, average crystallinity of the article molded with the viscosity-reducing additive is at least 2% greater than the overall, average crystallinity of the article produced without the viscosity-reducing additive.

As mentioned also, the invention involves injection molding crystalline or semicrystalline material to form products that do not change appreciably in crystallinity, over time, after removal from the mold. Specifically, injection-molded products do not change in crystallinity by more than about 10%, or preferably 8%, 6%, 4%, or 2% after 30 minutes after removal from the mold. Preferably, the product does not change in crystallinity more than 10% or other, lower percentage mentioned above after 1 hour, 5 hours, 1 day, 1 week, or 2 weeks after removal from the mold.

The function and advantage of these and other embodiments of the present invention will be more fully understood from the examples below. The following examples are intended to illustrate the benefits of the present invention, but do not exemplify the full scope of the invention. The examples below demonstrate advantages of injection molding of a charge of polymeric material and supercritical fluid blowing agent, in that articles are formed that have a surface, corresponding to an interior surface of a molding chamber, that is free of splay and swirl visible to the naked human eye.

### EXAMPLE 1 (COMPARATIVE)

### Solid Parts Molded Without Viscosity-Reducing Additive

A 150-ton Engel two stage injection molder was constructed with a 32:1 1/d, 40 mm plasticizing unit which feeds melted polymer into a 40 mm diameter plunger. The plunger and plasticizing units were connected by a spring loaded ball check joiner assembly. The plunger was able to inject into a mold through a typical pneumatically driven shut-off nozzle. Injection of a viscosity-reducing additive, specifically supercritical N₂ was accomplished by placing at approximately 16 to 20 diameters from the feed section an injection system that included one radially positioned port containing 176 orifices of 0.02 inch diameter. The injection system included an actuated control valve to meter a mass flow rate of blowing agent at rates from 0.2 to 12 lbs/hr.

The plasticator was equipped with a two stage screw including a conventional first stage feed, barrier, transition, and metering section, followed by a multi-flighted mixing section for blowing agent homogenization. The barrel was fitted with heating/cooling bands. The design allowed homogenization and cooling of the homogeneous single phase solution of polymer and gas.

An automotive intake gasket mold was connected with the injection molder to produce microcellular crystalline/semicrystalline foamed parts characteristics similar to or better than those of solid injection molded parts. The automotive intake gasket mold was a conventional two-cavity mold that operated with two plates and one parting line. It had a balanced two-cavity runner system with two tab gates per cavity. Use of the tab gates, one gate at each end of each part, can result in a weld line in the middle of the part. The glass filled nylon part that is produced in this mold is overmolded with silicon in a separate molding process to produce the seals on the finished product.

The design of the part is such that it has a nominal wall thickness of 0.116″. The part contains some channels for silicon overmolding that have a thickness of only 0.030″. The sprue is 3.40″ long with an entrance diameter of 0.220″ and an exit diameter of 0.350″. The runner system has diameter of 0.375″ along its entire 7.5″ flow length. The tab gates taper from the runner diameter to a 0.050″ by 0.615″ gate dimension.

Specific material used was DuPont Zytel 5105-305N, 33% glass fiber filled nylon 6/6.

The mold used was a 2-cavity automotive intake gasket 2-plate mold, with cold sprue and cold runner with 2 tab gates per cavity.

Solid parts were produced according to the material manufacturer's process recommendations. While processing the solid parts, an attempt was made to eliminate all signs of sink or shrinkage voids. These solid parts were then used as a baseline for weight reduction with the process described in example 2.

### EXAMPLE 2

### Injection Molding of Crystalline/Semicrystalline Material Using Viscosity-Reducing Additive

The system of example 1 was used to injection mold products. The resulting articles showed no signs of sink and replicated the mold cavity very well. All printing and date stamps on the articles (parts) were very clear. The parts did not have any detectable warpage when evaluated at the press. Weight reductions (void volumes) of 5%, 10%, 15%, and 20% were obtained in four specific examples.

Clamp force was reduced to demonstrate low pressure molding capability according to the process. While operating with a 10% weight reduction, clamp force was lowered to a level approaching 30 tons without any visual flash.

Overall cycle time was approximately 8 to 9 seconds, as compared with approximately 18 seconds in the solid process of example 1.

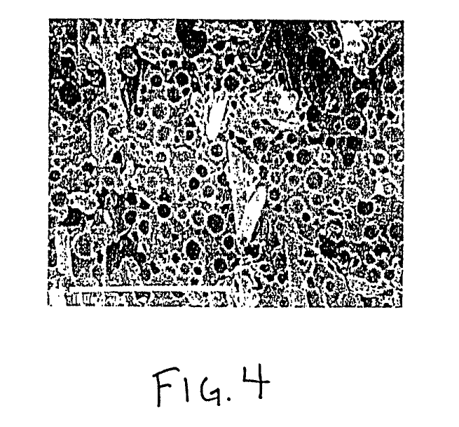

Excellent microcellular structure was observed. Cells were approximately 7 to 10 microns in diameter (FIG. 4). Good crystallinity resulted.

### EXAMPLE 3 (COMPARATIVE)

### Injection Molding of Crystalline/Semicrystalline Material Without a Viscosity-Reducing Additive

A system similar to that of example 1 was used, with the exception that a 66 ton Arburg reciprocating screw injection molding machine with vertical clamp was used. The mold was a single cavity bobbin encapsulation mold with parting line injection and cold runner.

Material used was Crastin SK 605 NC010 PBT. The mold was used to encapsulate an electrical coil. The coil had a weight of approximately 67.5 grams and the solid encapsulated part (a comparative example) had a weight of 82.7 grams with a runner weight of 5.5 grams. A primary concern in the industry in connection with this type of molding is damage to the wire caused by the pressure of the plastic in the cavity.

Solid parts, absent a viscosity-reducing additive, were molded at a melt temperature of 266° C. and mold temperature of 88° C. The part had a weight of approximately 87.2 grams solid. Cycle time was 45.28 seconds, including 8 seconds of hold time and 15 seconds of cooling time.

### EXAMPLE 4

### Injection Molding of Crystalline/Semicrystalline Material With a Viscosity-Reducing Additive

A viscosity-reducing additive, specifically supercritical nitrogen was used. In various trials, weight reduction (void volumes) of 5%, 10%, 20%, and approximately 25% were achieved. Flow rate of nitrogen was 0.3 lbs/hour. The level of nitrogen was approximately 0.8-0.9% relative to the weight of the polymer/nitrogen mixture. At a 5% weight reduction, the final part weight was 81.9 grams. Cycle time was decreased to 38.14 seconds. Table 1 contains a summary of part weights and cycle times.

TABLE 1

| | | Wt. Of | Wt. Red. For | | |
|---|---|---|---|---|---|
| | | Encap. Mat'l, | Encap. Mat'l, | Cycle Time, | Cycle Time |
| | Part Wt., gr | gr | % | sec | Red., % |
| Solid Controls | 82.7 | 15.2 | | 45.28 | |
| 5% Wt.Red. | 81.9 | 14.4 | 5.3 | 38.14 | 15.8% |
| 10% Wt. Red. | 81.3 | 13.8 | 9.2 | 37.89 | 16.3% |
| 20% Wt. Red. | 79.9 | 12.4 | 18.4 | 37.74 | 16.7% |
| 30% Wt. Red. | 78.6 | 11.1 | 27.0 | 37.59 | 17.0% |
| 10% Wt. Red. | 81.3 | 13.8 | 9.2 | 34.89 | 22.9% |
| 66° C. Mold | | | | | |
| 10% Wt.Red. | 81.3 | 13.8 | 9.2 | 32.89 | 27.4% |
| 38° C. Mold | | | | | |
| 10% Wt.Red. | 81.3 | 13.8 | 9.2 | 29.89 | 34% |
| 10° C. Mold | | | | | |

A second series of parts were run at 10% weight reduction (void volume). Mold temperature was dropped to 66° C., then 38° C., and finally to 10° C. As mold temperature dropped, cooling time required dropped from 15 seconds at 88° mold temperature to 7 seconds at 15° mold temperature. Cycle times of less than 30 seconds were achieved, 34% faster than for solid, comparative examples.

Various results of various runs follow.

Cycle time:

Without viscosity-reducing additive: 45.28 seconds

With viscosity-reducing additive:

37.59 seconds (17%) at a 42° C. mold temperature

29.89 seconds (34%) at a 10° C. mold temperature

Weight Reduction: A series of parts were produced with weight reductions in the encapsulating polymer of 5%, 10%, 20% and 27%.

Without viscosity-reducing additive: 82.7 grams, 15.2 grams of encapsulating resin.

With viscosity-reducing additive:

81.9 grams, 14.4 grams of encapsulating resin (5.3%)

81.3 grams, 13.8 grams of encapsulating resin (9.2%)

79.9 grams, 12.4 grams of encapsulating resin (18.4%)

78.6 grams, 11.1 grams of encapsulating resin (27.0%)

Cell Structure: The cell size was excellent at all weight reductions. The cell structure at 5% and 10% weight reductions were equivalent, less than 20 microns with most less than 10 microns. At 20% and 30% weight reduction, the cell size was 40 to 50 microns.

Clamp Tonnage: Clamp tonnage was reduced from 40 tons to 10 tons with use of a viscosity-reducing additive at 5% weight reduction.

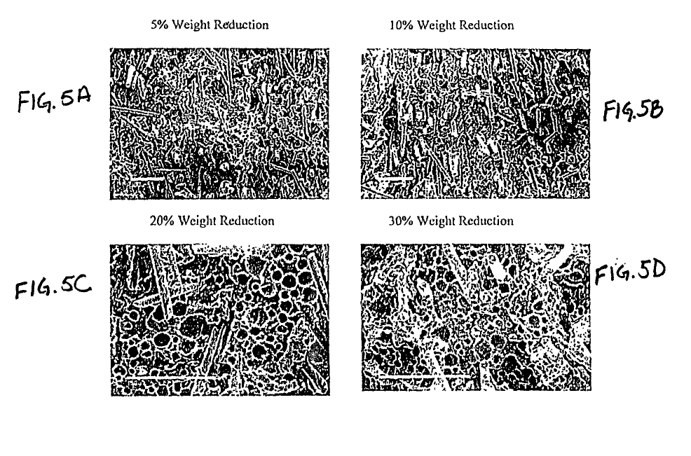

FIGS. 5A-5D are photocopies of SEM images of microcellular injection molded articles produced according to this example. Crystallinity was equivalent for all samples.

### EXAMPLE 5

### Injection Molding of 27-Tooth Test Gear

An Arburg 88 ton reciprocating screw injection molding machine was used. All materials used in the mold trial were from DuPont Polymers: Delrin 500P—unfilled Acetal; Delrin 525 GR—25% glass filled Acetal; Zytel 101L—unfilled Nylon; Zytel 70G33L—33% glass filled Nylon.

The mold was a single cavity 27-tooth test gear mold. A 3-plate mold was used with 3 drop pin-gates to the center of the part. The gear produced is 0.250 inches thick with a flow factor of 4:1. In the mold, balanced flow to the three gates was facilitated through the use of a thick disk opposite the main sprue that acts as a pressure-balancing manifold.

Parts were produced at weight reductions (void volumes) of 25%, 15%, and 5%. Initially, processing was used with Delrin 500P unfilled Acetal. Next, Zytel 70G33L Nylon was run, and finally Zytel 101L Nylon. The final material was processed at a 5% weight reduction.

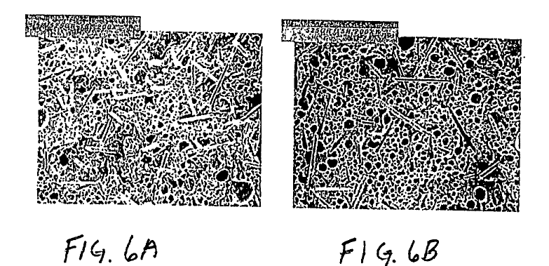

Samples exhibited good cell structure upon visual inspection. Cell size was generally between about 20 and about 100 microns. FIGS. 6A and 6B are photocopies of SEM images of selected results. FIG. 6A shows Delrin 525GR at 15% weight reduction at an injection rate of 10 cm³/s. FIG. 6B shows the same material at a faster injection rate of 90 cm³/s.

Full crystallinity was obtained in less than one week for all processing conditions described. This is to be compared to a time of three weeks required for attainment of equivalent crystallinity in comparative examples without use of a viscosity-reducing additive (comparative examples are not described in detail here).

Those skilled in the art would readily appreciate that all parameters listed herein are meant to be exemplary and that actual parameters will depend upon the specific application for which the methods and apparatus of the present invention are used. It is, therefore, to be understood that the foregoing embodiments are presented by way of example only and that, within the scope of the appended claims and equivalents thereto, the invention may be practiced otherwise than as specifically described. In the claims the words “including”, “carrying”, “having”, and the like mean, as “comprising”, including but not limited to.

What is claimed is:

1. An article comprising:
an injection molded crystalline or semicrystalline microcellular article including at least one portion having crystallinity of at least 25%.

2. An article as in claim 1, wherein the at least one portion has crystallinity of at least 30%.

3. An article as in claim 1, wherein the at least one portion has crystallinity of at least 35%.

4. An article as in claim 1, wherein the at least one portion has crystallinity of at least 40%.

5. An article as in claim 1, wherein the at least one portion has crystallinity of at least 45%.

6. An article as in claim 1, wherein at least 25% of the article's volume has crystallinity of at least 25%.

7. An article as in claim 1, wherein at least 50% of the article's volume has crystallinity of at least 25%.

8. An article as in claim 1, wherein at least 75% of the article's volume has crystallinity of at least 25%.

9. An article as in claim 1, wherein at least 90% of the article's volume has crystallinity of at least 25%.

10. An article as in claim 1, wherein essentially 100% of the article's volume has crystallinity of at least 25%.

11. An article as in claim 1, wherein at least 75% of the article's volume has a crystallinity of at least 45%.

12. An article as in claim 1, having a void volume of at least about 5%.

13. An article as in claim 1, having a void volume of at least about 10%.

14. An article as in claim 1, having a void volume of at least about 20%.

15. An article as in claim 1, the article having a surface, corresponding to an interior surface of a molding chamber, that is free of splay and swirl visible to the naked human eye.

16. An article as in claim 1, including residual chemical blowing agent or reaction of by-product of chemical blowing agent in an amount less than that inherently found in articles blown with about 0.1 % weight chemical blowing agent or more.

17. An article as in claim 1, further comprising a reinforcing agent.

18. An article as in claim 1, having an average cell size of less than about 100 microns.

19. An article as in claim 1, having an average cell size of less than about 30 microns.

20. An article as in claim 1, having an average cell size of less than about 50 microns.

21. An article as in claim 1, having an average cell size of less than about 5 microns.

22. An article as in claim 1, wherein the microcellular material is essentially closed-cell.

23. An article as in claim 1, including at least one portion having a cross-sectional dimension of no more than about 0.100 inch.

24. An article as in claim 1, comprising an injection molded polymeric foam having a void volume of at least about 5%, the article having a surface that is free of splay and swirl visible to the naked human eye.

25. An article as in claim 1, comprising an injection molded crystalline or semicrystalline article having at least one portion with a wall thickness of no more than about 0.125 inch and a crystallinity of at least about 25%.

26. A method comprising:
injection molding a crystalline or semicrystalline material at a mold temperature less than about 65° C.;
recovering from the mold a crystalline or semicrystalline material article including at least one portion having crystallinity of at least about 25%.

27. A method as in claim 26, comprising injection molding the material at a mold temperature less than about 55° C.

28. A method as in claim 26, comprising injection molding the material at a mold temperature less than about 45° C.

29. A method as in claim 26, comprising injection molding the material at a mold temperature less than about 30° C.

30. A method as in claim 26, comprising injection molding the material at a mold temperature less than about 20° C.

31. A method as in claim 26, comprising injection molding the material at a mold temperature less than about 10° C.

32. A method as in claim 26, comprising recovering an article including at least one portion having crystallinity of at least about 30%.

33. A method as in claim 26, comprising recovering an article including at least one portion having crystallinity of at least about 35%.

34. A method as in claim 26, comprising recovering an article including at least one portion having crystallinity of at least about 40%.

35. A method as in claim 26, wherein at least about 25% of the article has a crystallinity of at least about 25%.

36. A method as in claim 26, wherein at least about 50% of the article has a crystallinity of at least about 25%.

37. A method as in claim 26, wherein at least about 75% of the article has a crystallinity of at least about 25%.

38. A method as in claim 26, wherein at least about 90% of the article has a crystallinity of at least about 25%.

39. A method as in claim 26, comprising injecting a fluid, single-phase solution of a precursor of foamed polymeric material and a blowing agent into a molding chamber from an accumulator in fluid communication with extrusion apparatus while nucleating the solution to create a nucleated mixture; and
allowing the mixture to solidify as a polymeric foam article in the molding chamber.

40. A method as in claim 26, wherein the article is microcellular.

41. A method as in claim 39, comprising allowing the nucleated mixture to undergo cell growth, allowing the mixture to solidify in the shape of the enclosure to form a microcellular polymeric article in the shape of the enclosure, and removing the microcellular polymeric article from the enclosure while allowing the article to retain the shape of the enclosure.

42. A method as in claim 41, comprising continuously nucleating the stream by continuously subjecting the stream to a pressure drop at a rate sufficient to cause nucleation while passing the stream into the enclosure.

43. A method as in claim 26, wherein the material further comprises a reinforcing agent.

44. A method as in claim 26, comprising:
injecting a blowing agent into an extruder barrel of polymer extrusion apparatus while an extrusion screw is moving axially within the barrel, then injection molding the crystalline or semicrystalline material and recovering from the mold the crystalline or semicrystalline article.

45. A method as in claim 26, comprising injecting the crystalline or semicrystalline material into a mold, and recovering from the mold the crystalline or semicrystalline article within a period of time less than 10 seconds.

46. A method as in claim 26, comprising injection molding the material into a mold including a portion having an interior dimension of less than about 0.050 inch.

47. A method as in claim 26, comprising:
injecting a single phase solution of polymeric material and blowing agent into an open mold, then closing the mold and forming a microcellular article in the shape of the mold.

48. A method as in claim 26, comprising injecting the material into the mold at a mold temperature of less than about 50° C.

49. A method as in claim 26, comprising injecting the material into the mold at a mold temperature of less than about 30° C.

50. A method as in claim 26, comprising:
urging a stream of the crystalline or semicrystalline material flowing in a downstream direction with a barrel of an extrusion apparatus;
introducing a blowing agent into the stream at a rate metered by the mass flow of the blowing agent to form a mixture of fluid polymeric article precursor and blowing agent; and
injecting the mixture of fluid polymeric article precursor into the mold fluidly connected to the barrel.

51. A method as in claim 50, wherein the mixture of material and blowing agent comprises a single-phase solution.

52. A method as in claim 50, wherein the mass flow rate of the blowing agent is between about 0.05% and 25% based on the weight of the mixture of material and blowing agent.

53. A method as in claim 52, wherein the mass flow rate of the blowing agent is between 0.04 lbs/hour and 70 lbs/hour.

54. A method as in claim 50, wherein the blowing agent comprises carbon dioxide.

55. A method as in claim 50, wherein the blowing agent comprises nitrogen.

56. A method as in claim 50, wherein the blowing agent comprises helium.

57. A method comprising:
injection molding a crystalline or semicrystalline material in the absence of a viscosity-reducing additive at a first mold temperature and recovering from the mold a crystalline or semicrystalline article having crystallinity of a first value,
injection molding the material mixed with a viscosity-reducing additive at a second temperature at least 5° C. lower than the first mold temperature and recovering from the mold a crystalline or semicrystalline article having crystallinity of at least the first value.

58. A method as in claim 57, wherein the second temperature is at least 15° C. lower than the first temperature.

59. A method as in claim 57, wherein the material further comprises a reinforcing agent.

60. A method as in claim 57, wherein the second temperature is at least 25° C. lower than the first temperature.

61. A method as in claim 57, wherein the second temperature is at least 50° C. lower than the first temperature.

62. A method as in claim 57, wherein the second temperature is at least 75° C. lower than the first temperature.

63. A method comprising:
injection molding a crystalline or semicrystalline material mixed with a viscosity-reducing additive at a first mold temperature and recovering from the mold a crystalline or semicrystalline article having crystallinity of a first value,
wherein the material, injection molded under essentially identical conditions except in the absence of a viscosity-reducing additive and at a different mold and optionally different barrel temperature, requires molding at a second mold temperature at least 5° C. higher than the first temperature to produce a crystalline or semicrystalline article having crystallinity of at least the first value.

64. A method as in claim 63, wherein the second mold temperature is at least 15° C. higher than the first temperature.

65. A method as in claim 63, wherein the second mold temperature is at least 25° C. higher than the first temperature.

66. A method as in claim 63, wherein the material further comprises a reinforcing agent.

67. A method as in claim 63, wherein the second mold temperature is at least 50° C. higher than the first temperature.

68. A method as in claim 63, wherein the second mold temperature is at least 75° C. higher than the first temperature.

69. A method comprising:
injection molding a crystalline or semicrystalline material in the absence of a viscosity-reducing additive at a first mold temperature and recovering from the mold a first crystalline or semicrystalline article having a crystallinity of a first value;
injection molding the material mixed with a viscosity-reducing additive at a second mold temperature no greater than the first mold temperature and recovering from the mold a second crystalline or semicrystalline article having crystallinity at least 2% greater than the first value.

70. A method as in claim 69, wherein the second crystalline or semicrystalline article has crystallinity at least 5% greater than the first value.

71. A method as in claim 69, wherein the second crystalline or semicrystalline article has crystallinity at least 6% greater than the first value.

72. A method as in claim 69, wherein the second crystalline or semicrystalline article has crystallinity at least 8% greater than the first value.

73. A method as in claim 69, wherein the second crystalline or semicrystalline article has crystallinity at least 10% greater than the first value.

74. A method as in claim 69, wherein the material further comprises a reinforcing agent.

75. A method as in claim 69, wherein the second crystalline or semicrystalline article has crystallinity at least 20% greater than the first value.

76. A method comprising:
injection molding a crystalline or semicrystalline material mixed with a viscosity-reducing additive at a first mold temperature and recovering from the mold a first crystalline or semicrystalline article having crystallinity of a first value;
wherein the material, injection molded under essentially identical conditions except in the absence of a viscosity-reducing additive, results in a second crystalline or semicrystalline article having crystallinity at least 2% less than the first value.

77. A method as in claim 76, wherein the second article has crystallinity at least 5% less than the first value.

78. A method as in claim 76, wherein the material further comprises a reinforcing agent.

79. A method as in claim 76, wherein the second article has crystallinity at least 10% less than the first value.

80. A method as in claim 76, wherein the second article has crystallinity at least 20% less than the first value.

81. A method comprising:
injection molding a crystalline or semicrystalline material to form an injection-molded product that does not change in crystallinity more than 10% within 30 minutes after removal from the mold.

82. A method as in claim 81, wherein the product does not change in crystallinity more than 5% within 30 minutes after removal from the mold.

83. A method as in claim 81, wherein the product does not change in crystallinity more than 2% within 30 minutes after removal from the mold.

84. A method as in claim 81, wherein the product does not change in crystallinity more than 10% within 1 hour after removal from the mold.

85. A method as in claim 81, wherein the product does not change in crystallinity more than 10% within 5 hours after removal from the mold.

86. A method as in claim 81, wherein the product does not change in crystallinity more than 10% within one day after removal from the mold.

87. A method as in claim 81, wherein the product does not change in crystallinity more than 10% within one week after removal from the mold.

88. A method as in claim 81, wherein the product does not change in crystallinity more than 10% within 2 weeks after removal from the mold.

89. A method as in claim 81, wherein the material comprises an acetal.

90. A method as in claim 81, wherein the material comprises a polyester.

91. A method as in claim 81, wherein the material comprises polyethylene terephthalate.

92. An article comprising:
a crystalline or semicrystalline molded product formed by injection into a mold and subsequent removal from the mold, having a crystallinity measured at 30 minutes after removal from the mold that differs from its crystallinity upon removal from the mold by no more than 10%.

93. An article as in claim 92, wherein the product has a crystallinity measured at 30 minutes after removal from the mold that differs from its crystallinity upon removal from the mold by no more than 8%.

94. An article as in claim 92, wherein the product has a crystallinity measured at 30 minutes after removal from the mold that differs from its crystallinity upon removal from the mold by no more than 6%.

95. An article as in claim 92, wherein the product has a crystallinity measured at 30 minutes after removal from the mold that differs from its crystallinity upon removal from the mold by no more than 4%.

96. An article as in claim 92, wherein the product has a crystallinity measured at 30 minutes after removal from the mold that differs from its crystallinity upon removal from the mold by no more than 2%.

97. An article as in claim 92, wherein the product has a crystallinity measured at 1 hour after removal from the mold that differs from its crystallinity upon removal from the mold by no more than 10%.

98. An article as in claim 92, wherein the product has a crystallinity measured at 5 hours after removal from the mold that differs from its crystallinity upon removal from the mold by no more than 10%.

99. An article as in claim 92, wherein the product has a crystallinity measured at 1 day after removal from the mold that differs from its crystallinity upon removal from the mold by no more than 10%.

100. An article as in claim 92, wherein the product has a crystallinity measured at 1 week after removal from the mold that differs from its crystallinity upon removal from the mold by no more than 10%.

101. An article as in claim 92, wherein the product has a crystallinity measured at 2 weeks after removal from the mold that differs from its crystallinity upon removal from the mold by no more than 10%.

102. An article as in claim 92, wherein the product further comprises a reinforcing agent.

103. An article as in claim 92, wherein the product comprises an acetal.

104. A method as in claim 92, wherein the material comprises a polyester.

105. A method as in claim 92, wherein the material comprises polyethylene terephthalate.
